(19) United States
(12) Patent Application Publication
(10) Pub. No.: US 2026/0200112 A1
(43) Pub. Date: Jul. 16, 2026

(54) CLICK LEVER FOR HAIR CLIPPER

(71) Applicant: STYLECRAFT, LLC, Boca Raton, FL (US)

(72) Inventors: Brian KAUFMAN, Sutter, CA (US); Rigoberto HERNANDEZ, Yuba City, CA (US)

(73) Assignee: STYLECRAFT, LLC, Boca Raton, FL (US)

(21) Appl. No.: 19/020,188

(22) Filed: Jan. 14, 2025

(51) Int. Cl. B26B 19/38; B26B 19/20

(52) U.S. Cl. CPC B26B 19/3886; B26B 19/205

(57) ABSTRACT

A lever assembly and hair clipper with a lever assembly is provided. The lever assembly may include a shaft having a plurality of dimples arranged around a periphery thereof, a pin with an apex, the apex being shaped to mate with the dimples of the shaft, and a spring mounted on the pin. Moreover, the device may include a lever having a head section and an arm section; the head section of the lever including a cam protrusion, and a first cavity shaped to receive the shaft and defining an axis of rotation of the lever; and the arm section including a cavity that receives the pin and the spring, and aligns the apex of the pin with the dimples of the shaft.

### FIELD OF THE INVENTION

Various embodiments described herein generally relate to hair clippers. More specifically, embodiments herein relate to clippers with adjustable height distances between adjacent pairs of clipping blades, which provide an audible click when adjusted.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Prior art hair clippers cut hair by the interaction between a latterly moveable reciprocating blade and a laterally fixed stationary blade. The reciprocating blade will move laterally at a high frequency under power from an electric motor. Running the clipper over hair catches hair between the teeth of the stationary blade and the reciprocating blade. The clipper clips hair caught between the stationary blade and the reciprocating blade as the clipper moves along the user's skin.

In some clippers, such as U.S. Pat. No. 9,144,911 incorporated herein by reference in its entirety, the height of the stationary blade is adjustable to vary the distance between the stationary blade and the reciprocating blade. The height difference will establish the length of hair that will remain after a pass of the clipper over a user's skin. The user or their stylist adjusts the height of the adjustable blade to a desired height position such that the teeth of the adjustable blade are a desired distance from the teeth of the reciprocating blade.

Referring now to FIG. 1, a prior art clipper 100 with a height-adjustable stationary blade 102 is shown. The stationary blade 102 is mounted on a taper adjustment bar 104 with a hole (not shown). The taper adjustment bar 104 is slidably mounted on a body 106 of the clipper 100. A lever 108 is also mounted to the body 106 by a screw 110. A cam (not shown) at the end of lever 108 engages with the hole of taper adjustment bar 104. Movement of reciprocating blade 114 relative to stationary blade 102 cuts hair trapped between the teeth to a length based on the height difference between the reciprocating blade 114 relative to stationary blade 102.

When the lever 108 rotates counterclockwise around the screw 110, engagement of the cam with the hole of the taper adjustment bar 104 pushes the taper adjustment bar 104 to a lower height; this moves the teeth of the stationary blade 102 toward the teeth of the reciprocating blade 114, for which the shorter distance results in shorter hair. When the lever 108 rotates around the screw 110 clockwise, engagement of the cam 112 with the hole of the taper adjustment bar 104 pushes the tamper adjustment bar 105 to a greater height; this moves the teeth of the stationary blade 102 further away from the teeth of the reciprocating blade 114, for which the longer distance results in longer hair.

The above design uses a so-called “floating blade lever” in that the adjustable blade has no set positions. Without set positions, height adjustments are within the stylist's skill and discretion, for which there is no consistency in hair length between different visits to the stylist.

Referring now to FIG. 2, another type of prior art clipper 200 uses a so-called “click lever” 202. In this device, a curved plate 204 is attached to the outer body 206 of the clipper. The curved plate 204 has several openings. The click lever 202, as mounted by an ordinary screw 210, is similar to lever 108 except click lever 202 has a protrusion 208, and the curvature of curved plate 204 tracks the protrusion 208's arc of movement as click lever 202 rotates about ordinary screw 210.

As the click lever 202 rotates about ordinary screw 210, the protrusion 208 will engage one of the openings, which holds the click lever 202 in place at that position to establish a fixed length position for the adjustable blade; the various openings in the curved plate 204 thus establish fixed height positions of the stationary blade relative to the reciprocating blade to set fixed height settings to cut hair.

Applying sufficient pressure will dislodge the protrusion 208 from a particular opening, allowing the click lever 202 to move the protrusion 208 to a different opening and establish a different height differential for the blades.

The fixed height positions ensure the uniform length selection between different stylist visits and even between stylists. An added benefit is that movement of protrusion 208 into a particular opening of the curved plate 204 generates an audible “click” sound so the stylist can count the clicks to determine the desired location. A customer can, therefore, provide the stylist with a click number for their desired hair length.

The above clipper 200 has several drawbacks. Given the size limitations of the curved plate 204, physical space limits the height adjustment range to upwards of five openings to allow for five fixed-length positions of the adjustable blade. This physical range is smaller than the full height range available between the blades, such that when the protrusion 208 moves past the curved plate 204, the click lever 202 acts like a floating lever.

Another drawback is that the click lever 202 is only effective on a clipper with the curved plate 204 mounted on the body. Prior art clippers 100 with floating levers cannot be retrofitted to work with click lever 202 absent complete replacement of the body and lever.

### SUMMARY

According to an aspect of the present disclosure, a lever assembly is provided. The lever assembly includes: a shaft having a plurality of dimples arranged around a periphery thereof, and threads at one end thereof; a pin with an apex, the apex being shaped to mate with the dimples of the shaft; a spring mounted on the pin; a lever having a head section and an arm section; the head section of the lever including a cam protrusion, and a first cavity shaped to receive the shaft and defining an axis of rotation of the lever; and the arm section including a cavity that receives the pin and the spring, and aligns the apex of the pin with the dimples of the shaft.

The above aspect may have various features. The shaft may include a threaded section, a smooth section, a ring section supporting the dimples, and a head, wherein a diameter of the ring section is larger than a diameter of the smooth section. The dimples may be equidistant from each other around the shaft. The spring may bias the apex toward the dimples. When the apex aligns with a particular dimple of the dimples, the pin may engage under spring force from the spring to engage the apex of the pin with the particular dimple of the dimples to lock the pin and the shaft together. When the apex is locked to particular dimple, application of sufficient rotational force to the lever may rotate the lever relative to the shaft, forcing the apex to disengage the particular dimple. An audible and/or tactile click may be generated in response to the apex engaging a particular dimple. The cam protrusion may be shaped to engage with a blade height adjuster of hair clipper. The lever assembly may be mounted on a hair clipper by the shaft. The lever assembly may further include: a hair clipper having a blade height adjuster; the lever assembly is mounted on a hair clipper by the shaft; wherein the cam protrusion is shaped to engage with a blade height adjuster of the hair clipper; wherein application of rotational force to the lever assembly rotates the lever, which rotates the cam protrusion and adjust the blade height adjuster to alter a height of a blade of the hair clipper; wherein when the apex aligns with a particular dimple of the dimples, the pin engages under spring force from the spring to engage the apex of the pin with the particular dimple of the dimples to lock the pin and the shaft together, and thereby lock the blade height adjuster to a predetermined blade height for the hair clipper.

According to another aspect of the invention, a hair clipper lever assembly, is provided. It includes a hair clipper having a blade height adjuster and a lever assembly that includes: a shaft having a plurality of dimples arranged around a periphery thereof, and threads at one end thereof; a pin with an apex, the apex being shaped to mate with the dimples of the shaft; a spring mounted on the pin; a lever having a head section and an arm section; the head section of the lever including a cam protrusion that engages the blade height adjuster, and a first cavity shaped to receive the shaft and defining an axis of rotation of the lever; and the arm section including a cavity that receives the pin and the spring, and aligns the apex of the pin with the dimples of the shaft. The lever assembly is mounted on the hair clipper by the shaft.

The above aspect may have various features. The shaft may include a threaded section, a smooth section, a ring section supporting the dimples, and a head, wherein a diameter of the ring section is larger than a diameter of the smooth section. The dimples may be equidistant from each other around the shaft. The spring may bias the apex toward the dimples. When the apex aligns with a particular dimple of the dimples, the pin may engage under spring force from the spring to engage the apex of the pin with the particular dimple of the dimples to lock the pin and the shaft together. When the apex is locked to particular dimple, application of sufficient rotational force to the lever may rotate the lever relative to the shaft, forcing the apex to disengage the particular dimple. An audible and/or tactile click may be generated in response to the apex engaging a particular dimple. The cam protrusion may be shaped to engage with a blade height adjuster of hair clipper. The lever assembly may be mounted on a hair clipper by the shaft. The cam protrusion is shaped to engage with a blade height adjuster of the hair clipper such that application of rotational force to the lever assembly rotates the lever, which rotates the cam protrusion and adjust the blade height adjuster to alter a height of a blade of the hair clipper, and when the apex aligns with a particular dimple of the dimples, the pin engages under spring force from the spring to engage the apex of the pin with the particular dimple of the dimples to lock the pin and the shaft together, and thereby lock the blade height adjuster to a predetermined blade height for the hair clipper.

### DRAWINGS

Various embodiments in accordance with the present disclosure will be described with reference to the drawings, as follows.

FIG. 1 shows a prior art hair clipper with a floating head lever.

FIG. 2A and B show a prior art hair clipper with a prior art click lever.

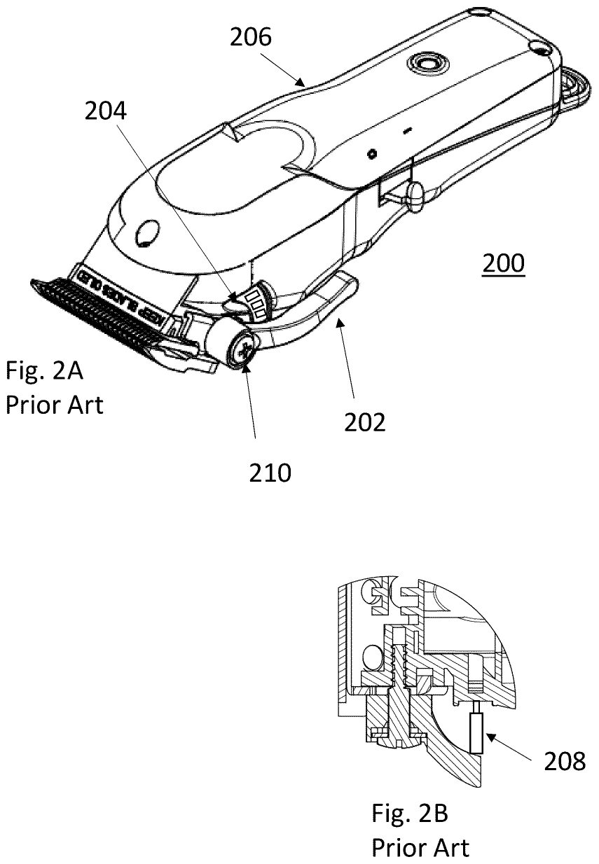

FIGS. 3A-D show an embodiment of a shaft.

FIGS. 4A-D show an embodiment of a pin for use with the shaft of FIG. 3A.

FIGS. 5A-D show an embodiment of a lever for use with the shaft of FIG. 3A and pin of FIG. 4A.

FIG. 6 shows an embodiment of the assembled lever, shaft, and pin.

FIG. 7 shows another embodiment of a shaft.

FIG. 8 shows another embodiment of a pin.

FIG. 9 shows another embodiment of a lever.

FIG. 10 shows the assembly of FIG. 6 mounted on a hair clipper.

FIGS. 11A-D shows another embodiment a click lever assembly.

FIG. 12 shows another embodiment a click lever assembly.

FIG. 13 shows a click lever assembly with an alignment guide.

FIGS. 14A and 14B shows another embodiment of a lever.

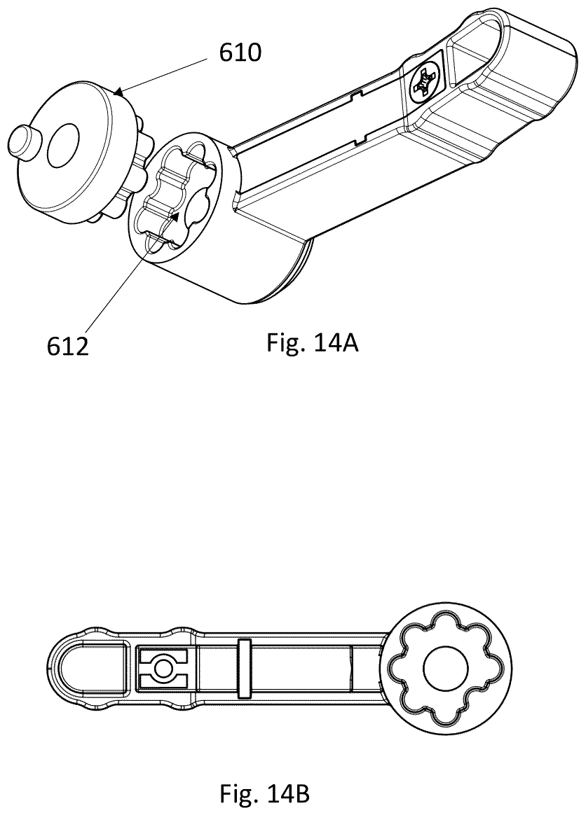

All figures are to scale unless otherwise indicated.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring example embodiments.

References to one or an embodiment in the present disclosure can be, but not necessarily are, references to the same embodiment; and, such references mean at least one of the embodiments.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ±5% may be expected.

“First,” “second,” etc., re labels to distinguish components or blocks of otherwise similar names, but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

A “detent” refers to component or collection of components that temporarily locks a moving part in a specific position. Detents use a spring-loaded component that fits into a corresponding notch or groove to provide resistance or “hold” at specific points, allowing for controlled movement between them. This mechanism prevents unintended movement by creating a tactile stopping point until enough force is applied to overcome the spring force and dislodge the spring loaded component from the notch/groove.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

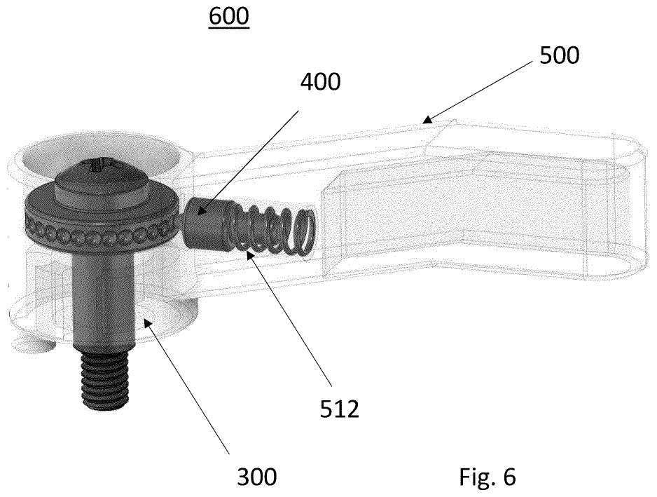

Referring now to FIG. 6, an embodiment of a click lever assembly 600 is shown. The click lever includes a shaft 300, a pin 400 biased by a spring 512, and a lever 500 that supports the shaft 300 and the pin 400.

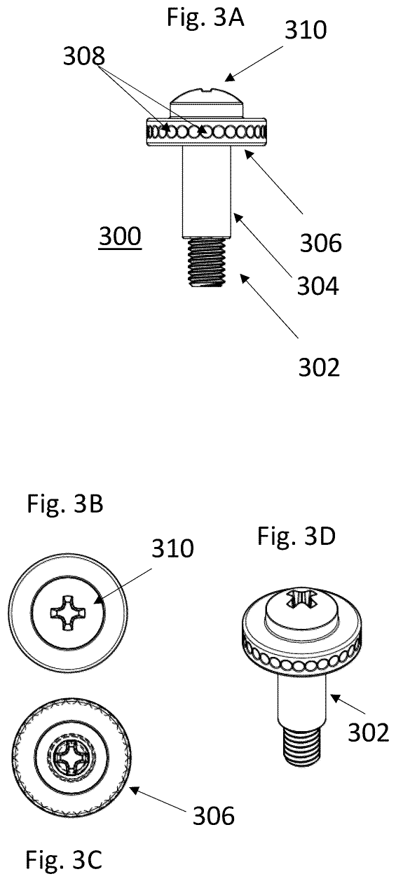

Referring now to FIGS. 3A-D, the shaft 300 includes a threaded section 302, a smooth section 304, a ring section 306 supporting dimples 308, and a head 310. The diameter of the ring section 306 is larger than the diameter of the smooth section 304, although this need not be the case and the invention is not so limited. Dimples 308 may be equidistant from each other around the entire ring section 306, although the invention is not so limited, and other distances and coverages could be used. Head 310 includes an engagement head shape to rotate the threaded section 302, such as a screw head or bolt head (a Philips shape is shown in the figures), although the invention is not limited to any particular head configuration.

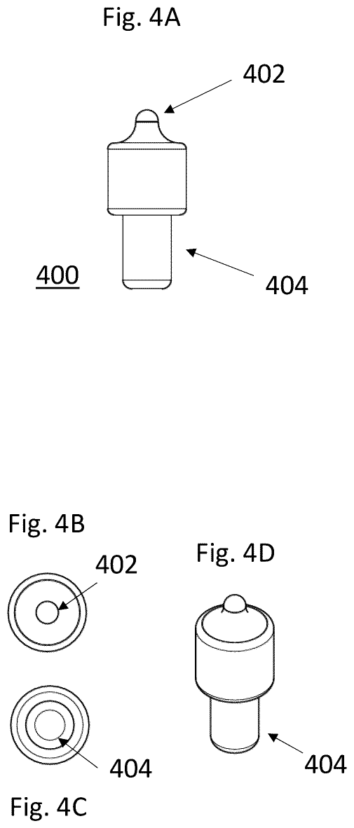

Referring now to FIGS. 4A-D, the pin 400 includes at one end an apex 402 shaped to engage with the dimples 308 and, at the other end, a receiving area 404 to receive the spring 512. The figures show apex 402 as a rounded point, but the invention is not limited to any particular shape.

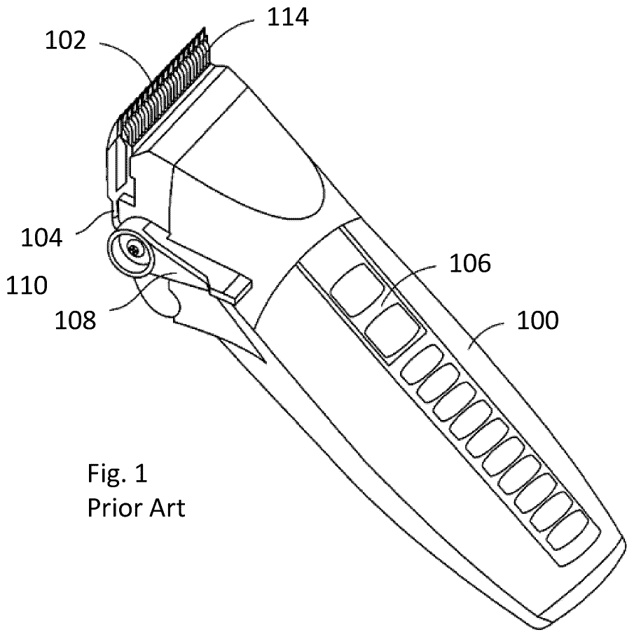

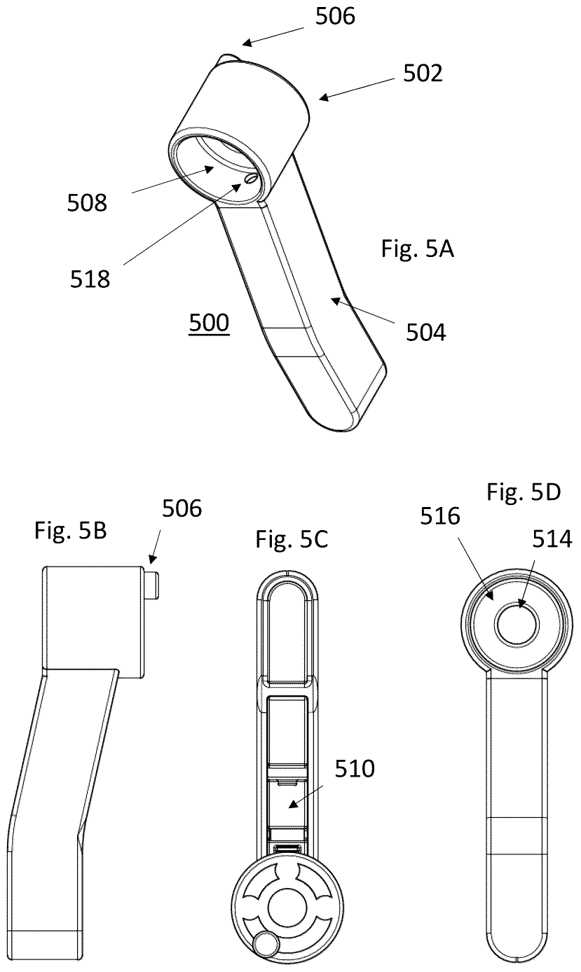

Referring now to FIGS. 5A-D, the lever 500 includes a head section 502 and an arm section 504. Head section 502 includes a cam 506 sized and positioned to engage a taper adjustment bar of a hair clipper (akin to that shown in FIG. 1), thereby adjusting the height difference in the blades of a clipper in the manner discussed with respect to FIG. 1.

Head section 502 also includes a cavity 508 to receive the shaft 300. As discussed above, shaft 300 may include different diameter sections, and thus cavity 508 may include a first smaller diameter 514 to accommodate the threaded section 302 and smooth section 304 and a second larger diameter 516 to accommodate ring section 306. As discussed in more detail below, the threaded section 302 will pass through the head section 502 to attach lever 500 to the body of a clipper, while ring section 306 will rest in the cavity 508.

Click lever assembly 600 can be retrofitted onto an existing clipper, such as the clipper in FIG. 1, by first removing the existing screw 110 and lever 108. To mount lever 500 to a clipper, the shaft 300 inserts into cavity 508, with the threaded section 302 engaging mating threads on the body 106 of clipper 100 in a manner consistent with as known in the art. Cavity 508 and shaft 300 establish an axis of rotation for lever 500 about the clipper 100, such that rotation of lever 500 and cam 506 adjusts the position of a clipper taper adjustment bar and the height difference in the blades of a clipper in the manner consistent with that discussed with respect to FIG. 1.

Referring now also to FIG. 6, arm section 504 includes a cavity 510 to receive pin 400 and spring 512, specifically aligning pin 400 with the apex 402 pointing toward the dimples 308 within cavity 508. Spring 512 biases the apex 402 toward the dimples 308 through a hole 518 in cavity 510.

The above combination of components creates a detent. When the apex 402 aligns with a particular dimple 308, bias from spring 512 engages pin 400 with the particular aligned dimple 308 to lock shaft 300 and pin 400 together. The engagement may create an audible “click” sound and/or a vibration that the user can feel via tactile response. Each dimple 308 thus establishes a fixed length. Applying sufficient force to the lever 500 will rotate the lever 500 relative to the shaft 300, overcoming the bias of spring 512 to force the apex 402 to disengage the particular dimple 308. Rotation by only a few degrees (e.g., the angular distance between the center distance of the dimples) will cause the lever 500 to align pin 400 over an adjacent dimple 308, clicking into place.

Shaft 300 is shown with thirty dimples 308, equidistant around ring section 306 at approximately 12 degree intervals. This provides thirty different click positions, each of which adjusts the height of the blades by about 1 mm. However, the invention is not so limited, and any number of dimples 308 or angles may be used. The diameter of the ring section 306, in part, contributes to the number of available dimples 308, as larger diameters can accommodate more dimples 308.

As a practical matter, the overall rotation of lever 500 is limited by the full height adjustment scope of the blades 102/114 of about 6 mm for about 30 degrees over overall rotation. Some dimples 308 will, therefore, never be used once shaft 300 is installed. Nonetheless, the extra dimples provide value because there is no specific alignment concern when installing shaft 300.

The above embodiments provide a click lever for a hair clipper, as well as a hair clipper with such a click lever. Each dimple 308 relative to pin 400 establishes a potential fixed position of the lever 500, which through its cam 506 and engagement with the height adjustment mechanism of a clipper establishes fixed heights of the clipper's stationary blade relative to its stationary blade. As lever 500 rotates counterclockwise, the apex 402 of pin 400 will sequentially engage dimples 308, each engagement generating an audible or tactile “click” that can be counted and used as a metric for describing a hair cut length.

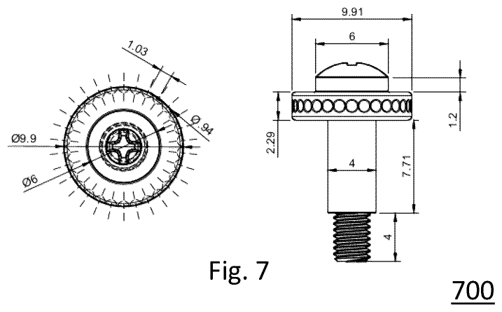

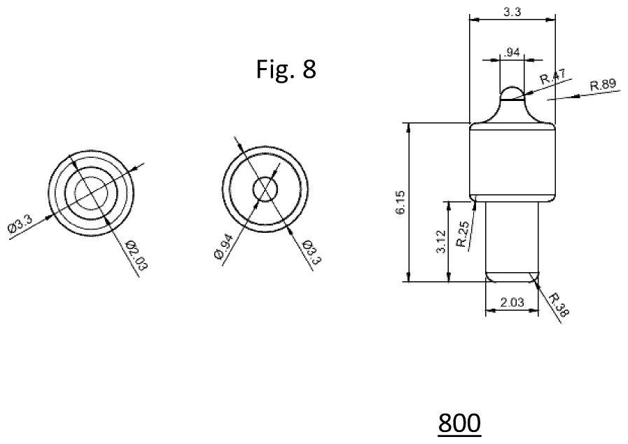

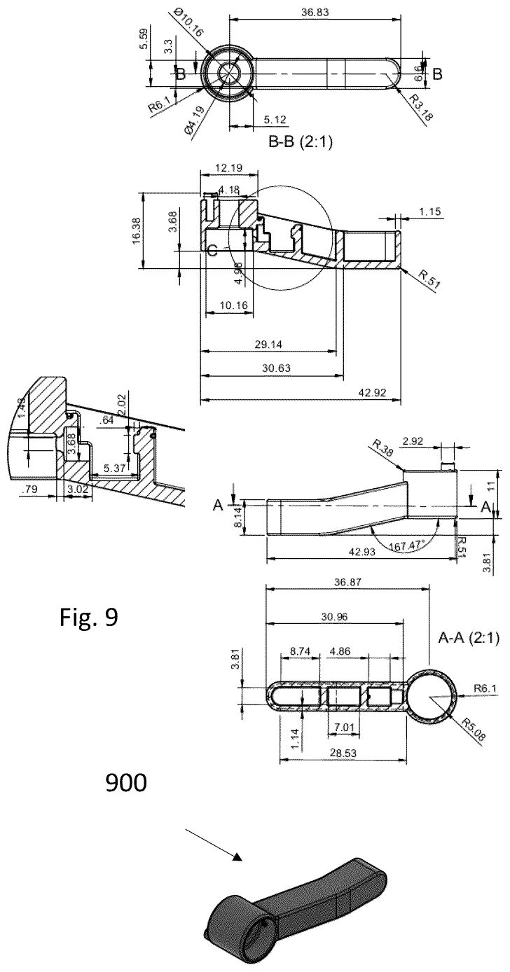

FIGS. 7-9 show non-limiting examples of sizes and angles for shaft 300, pin 400, and lever 500. However, the invention is not so limited, and other sizes may be used as appropriate.

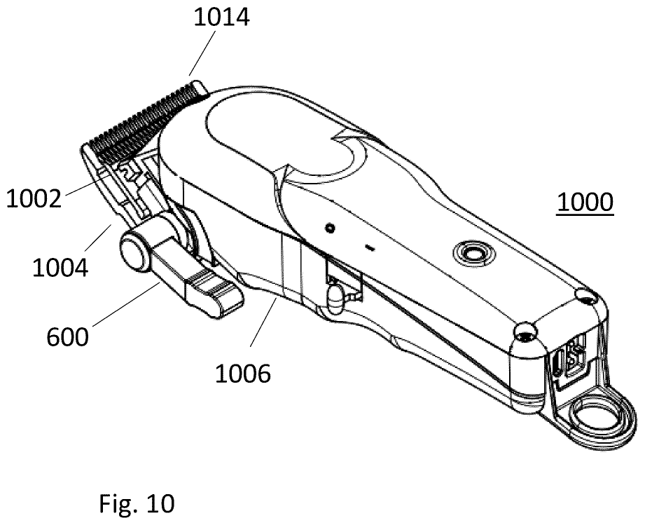

Referring now to FIG. 10, the click lever assembly 600 is mounted on a clipper 1000 with a stationary blade 1002, taper adjustment bar 1004, body 1006, and reciprocating blade 1014.

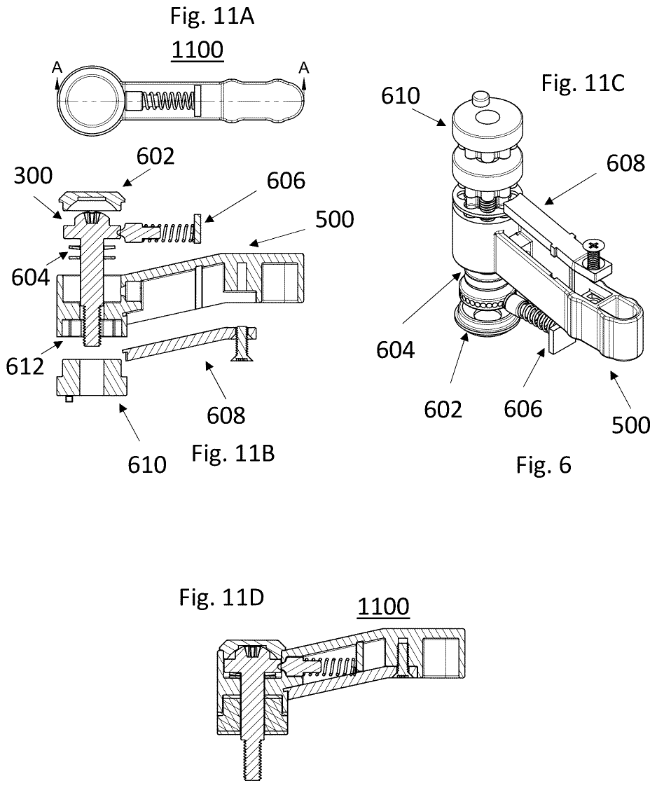

Referring now to FIGS. 11A-11C, another embodiment of the invention is shown. Shaft 300, pin 400, and lever 500 are present as shown from other figures, along with several other components.

A cap 602 covers the head 310 of shaft 300. One of more washers 604, any of which may be spring washers, may be slid onto smooth section 304 of shaft 300. A plate 606 provides a support in lever 500 against which spring 512 can apply rearward pressure. A cover 608 covers cavity 510 of arm section 504 to retain pin 400 and spring 512.

Head section 502 in FIG. 5 is shown as a unitary piece, but the invention as not so limited. FIGS. 11A-D and 14A-B shows that the head section 502 may be multiple pieces. By way of non-limiting example, head section 502 may include one or more interchangeable bases 610 that fit into a recess 612. These bases 610, which may be of different sizes, may be useful to incorporate click lever assembly 600 onto different clippers with different body shapes and screw wells that may not match the depth of threaded section 302 of shaft 300.

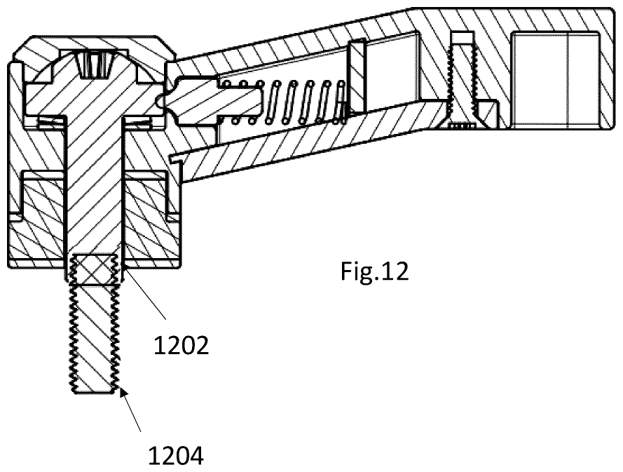

The shaft 300 may be a unitary piece. However, the invention is not so limited, and it may be made from multiple pieces. Referring now to FIG. 12, the shaft 300 may include a threaded bore 1202 and a threaded bolt 1204. Threaded bolt 1204 may have an appropriate length to mate different clippers with different body shapes and screw wells.

In any particular installation of lever 500, there may be some slight variance in the final angular position of the dimples 308, and thus the heights of the blades of any particular clipper.

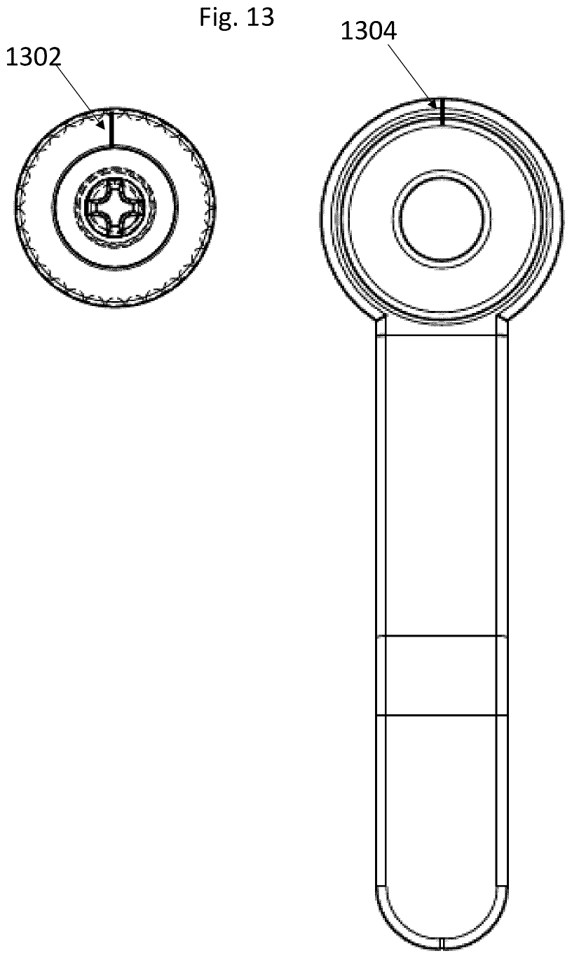

Referring now to FIG. 13, to minimize clipper-to-clipper variance, ring section 306 may be provided with one or more alignment guides 1302 for alignment with or more matching alignment guides 1304 on lever 500. Tightening shaft 300 to bring the guides into alignment would create a more uniform spacing clipper-to-clipper so the same user or stylist would be working off the same fixed heights.

Dimples 308 are shown as recessed, while the apex is shown as a rounded protrusion. However, the invention is not so limited. The dimples could be rounded bumps, while the apex has a recess.

Spring 512 is shown as a coil spring, but the invention is not so limited. Any spring type or shape of appropriate size may be used.

The above embodiments overcome the drawbacks of the prior art.

As discussed above, prior art click blade levers were limited to the number of openings on the curved plate (typically five due to space considerations) that did not accommodate the full height adjustment range of the blades. In contrast, the above embodiments are only limited by the number of dimples 308 in the periphery of the ring section 306, which can accommodate the full height adjustment range of the blades.

Also, the prior art clippers 100 and 200 can be retrofitted by removing their screw 110 and lever 108 and replacing them with a click lever assembly 600 herein of appropriate size.

The click lever assembly 600 and 1100 have been described above as a replacement part or as an upgrade/modification for an existing hair clipper, such as clipper 100 or 200, although the invention is not limited to any particular type of clipper. However, the click lever assembly 600 could be part of an originally manufactured clipper.

While click lever assembly 600 and 1100 have been described in the environment of a hair clipper, the invention is not so limited. The click lever assembly 600 could also be used in other environments beyond hair clippers.

The specification and drawings are to be regarded in an illustrative rather than a restrictive sense. It will, however, be evident that various modifications and changes may be made thereunto without departing from the broader spirit and scope of the invention as set forth in the claims.

What is claimed is:

1. A lever assembly, comprising:
a shaft having a plurality of dimples arranged around a periphery thereof, and threads at one end thereof;
a pin with an apex, the apex being shaped to mate with the dimples of the shaft;
a spring mounted on the pin;
a lever having a head section and an arm section;
the head section of the lever including a cam protrusion, and a first cavity shaped to receive the shaft and defining an axis of rotation of the lever; and
the arm section including a cavity that receives the pin and the spring, and aligns the apex of the pin with the dimples of the shaft.

2. The lever assembly of claim 1, wherein the shaft includes a threaded section, a smooth section, a ring section supporting the dimples, and a head, wherein a diameter of the ring section is larger than a diameter of the smooth section.

3. The lever assembly of claim 1, wherein the dimples are equidistant from each other around the shaft.

4. The lever assembly of claim 1, wherein the spring biases the apex toward the dimples.

5. The lever assembly of claim 1, wherein when the apex aligns with a particular dimple of the dimples, the pin engages under spring force from the spring to engage the apex of the pin with the particular dimple of the dimples to lock the pin and the shaft together.

6. The lever assembly of claim 5, wherein, when the apex is locked to particular dimple, application of sufficient rotational force to the lever will rotate the lever relative to the shaft, forcing the apex to disengage the particular dimple.

7. The lever assembly of claim 5, wherein an audible and/or tactile click is generated in response to the apex engaging a particular dimple.

8. The lever assembly of claim 1, wherein the cam protrusion is shaped to engage with a blade height adjuster of hair clipper.

9. The lever assembly of claim 1, wherein the lever assembly is mounted on a hair clipper by the shaft.

10. The lever assembly of claim 1, further comprising:
a hair clipper having a blade height adjuster;
the lever assembly is mounted on a hair clipper by the shaft;
wherein the cam protrusion is shaped to engage with a blade height adjuster of the hair clipper;
wherein application of rotational force to the lever assembly rotates the lever, which rotates the cam protrusion and adjust the blade height adjuster to alter a height of a blade of the hair clipper;
wherein when the apex aligns with a particular dimple of the dimples, the pin engages under spring force from the spring to engage the apex of the pin with the particular dimple of the dimples to lock the pin and the shaft together, and thereby lock the blade height adjuster to a predetermined blade height for the hair clipper.

11. A hair clipper lever assembly, comprising:
a hair clipper having a blade height adjuster;
a lever assembly comprising:
a shaft having a plurality of dimples arranged around a periphery thereof, and threads at one end thereof;
a pin with an apex, the apex being shaped to mate with the dimples of the shaft;
a spring mounted on the pin;
a lever having a head section and an arm section;
the head section of the lever including a cam protrusion that engages the blade height adjuster, and a first cavity shaped to receive the shaft and defining an axis of rotation of the lever; and
the arm section including a cavity that receives the pin and the spring, and aligns the apex of the pin with the dimples of the shaft; and
the lever assembly being mounted on the hair clipper by the shaft.

12. The hair clipper lever assembly of claim 11, wherein the shaft includes a threaded section, a smooth section, a ring section supporting the dimples, and a head, wherein a diameter of the ring section is larger than a diameter of the smooth section.

13. The hair clipper lever assembly of claim 11, wherein the dimples are equidistant from each other around the shaft.

14. The hair clipper lever assembly of claim 11, wherein the spring biases the apex toward the dimples.

15. The hair clipper lever assembly of claim 11, wherein when the apex aligns with a particular dimple of the dimples, the pin engages under spring force from the spring to engage the apex of the pin with the particular dimple of the dimples to lock the pin and the shaft together.

16. The hair clipper lever assembly of claim 15, wherein, when the apex is locked to particular dimple, application of sufficient rotational force to the lever will rotate the lever relative to the shaft, forcing the apex to disengage the particular dimple.

17. The hair clipper lever assembly of claim 15, wherein an audible and/or tactile click is generated in response to the apex engaging a particular dimple.

18. The hair clipper lever assembly of claim 11, wherein:
the cam protrusion is shaped to engage with a blade height adjuster of the hair clipper;
application of rotational force to the lever assembly rotates the lever, which rotates the cam protrusion and adjust the blade height adjuster to alter a height of a blade of the hair clipper; and
when the apex aligns with a particular dimple of the dimples, the pin engages under spring force from the spring to engage the apex of the pin with the particular dimple of the dimples to lock the pin and the shaft together, and thereby lock the blade height adjuster to a predetermined blade height for the hair clipper.
